(19) United States
(12) Patent Application Publication
(10) Pub. No.: US 2019/0250941 A1
(43) Pub. Date: Aug. 15, 2019

(54) FPGA PLATFORM AS A SERVICE (PAAS)

(71) Applicant: SRC LABS, LLC, Colorado Springs, CO (US)

(72) Inventors: Todd A. Rooke, Colorado Springs, CO (US); Timothy P. Wilkinson, Colorado Springs, CO (US)

(21) Appl. No.: 16/343,401

(22) PCT Filed: Oct. 18, 2017
(86) PCT No.: PCT/US2017/057274

§ 371 Date: Apr. 18, 2019

Related U.S. Application Data
(60) Provisional application No. 62/409,855, filed on Oct. 18, 2016.

(51) Int. Cl. G06F 9/455; G06F 17/50; G06F 9/50; G06F 9/448; H04L 29/08

(52) U.S. Cl. CPC G06F 9/45558; G06F 17/5054; G06F 2009/45591; G06F 9/4494; H04L 67/2861; G06F 9/5072

(57) ABSTRACT

The FPGA PaaS enables enterprise developers to easily build applications using its' marketplace components, apps, and stream services. The FPGA PaaS provides its capabilities to its FPGA PaaS enterprise developers.

### BACKGROUND

High performance computing solutions are used in enterprise-scale applications in order to operate applications with speed, efficiency and reliability. For example, Google offers a Tensor Processing Unit (TPU), which is a custom built application specific integrated circuit that is specifically tailored to machine learning applications. The TPU (or TPUs) is used with other general purpose processors to accelerate specified processing tasks for machine learning workloads within a data center. Reconfigurable computing is another methodology to provide high performance processing of information utilizing high-speed computing fabrics such as a network including a number of Field Programmable Gate Arrays (FPGAs). Similar to the approach identified above, one current architecture uses a general purpose processor and an array of reconfigurable hardware processors as accelerators. One current approach by Microsoft initially started as the Catapult project that powers its Bing search algorithm. By using a general purpose processor in conjunction with an FPGA, Microsoft has reported a 40× performance increase related to processing the algorithm and a 2× overall system performance increase. Microsoft moved this FPGA accelerator work forward and enabled artificial intelligence natively within their Office 365® and across their Azure® cloud platform. Similarly, IBM and Xilinx have announced a collaboration to enable FPGA accelerators for use in data center architectures.

In the current approaches identified above, the general purpose processor controls the behavior of the accelerator processors, which are programmed to perform a specific task such as image processing or pattern matching. Once the particular task is complete, the general purpose processor then coordinates further tasks so that a subsequent process can be completed. As such, some advantages related to speed can be obtained, since the processing tasks would be done with specifically configured hardware. However, processor coordination and data movement needed for this system using general purpose processors provides delays, latency, and inherent security vulnerabilities resulting from its operating system's blind execution on the general purpose processor given that the operating system inherently cannot distinguish malicious code from intended code execution. In other configurations, customized processors are configured to act as accelerators or operate similar to a coprocessor, again operating in conjunction with general purpose processors and inherently insecure operating systems.

The latest in what is becoming a long line of data breaches is at Equifax, where the financial and largely unchangeable personal data of over 145,000,000 U.S. consumers has been compromised. While there is an increasing desire to improve the ability of computer systems to resist cyber-attacks, such high profile attacks are common place in many fields including government personnel record keeping, retail transaction processing and social media. Many attempts have been made to improve the basic security features such as ever more complex passwords and biometric access, yet these have done little to significantly reduce the attack surface of a typical microprocessor based computer system. The vast majority of such attacks exploit features or holes in the underlying software operating system (OS), causing the microprocessor to perform undesired functions. As a result, most data center compliance certification organizations such as HIPPA, PCI or FEDRAMP require that these data centers review published lists of OS security vulnerabilities on a daily basis and implement patches for the identified vulnerabilities. These efforts are in attempt to try to stay one step ahead of hackers, but further vulnerabilities continue to be detected.

In addition to the security challenges noted above, a general purpose processor based computer system is also inherently inefficient at simultaneously executing an application and executing continuous monitoring of the application. In computer applications, it is often beneficial to be able to monitor a variety of events that may occur during the execution of the application. These events may give the user insight into the applications performance or overall system health. Unfortunately, monitoring events such as this in present day instruction flow microprocessor based computer systems comes at a price. In order to add the desired monitoring into the application program, the developer must add additional software steps. These steps then must be executed by the microprocessor, thus consuming processing clock cycles and also altering the instruction execution of the original application. Since it would not be uncommon for millions of these events to be generated by an application, it becomes easy to see that the overall application performance will suffer. Consequently, any monitoring of events in an instruction processor will slow its application performance, making it impractical to monitor events at such a desired level.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An FPGA Platform as a Service (PaaS) is disclosed that utilizes several different features in order to remotely build, operate, monitor and update an enterprise application on an enterprise supercompute platform where the primary compute is performed with one or more reconfigurable processors. In one embodiment, the entire computing platform is performed without the use of an operating system instructing the processors. The opportunity to develop and operate enterprise applications that utilize a marketplace of metered processing elements is made possible through a trusted FPGA PaaS. As such, enterprise developers can build applications by assembling various processing elements into an application. The PaaS also provides an easy to use integrated development environment providing its capabilities to FPGA PaaS enterprise developers.

### BRIEF DESCRIPTION OF THE DRAWINGS

FIG. 1 is a block diagram of an FPGA Platform as a Service (PaaS).

FIG. 2 is a block diagram of an FPGA application processing messages using a plurality of nodes.

FIG. 3A is a block diagram of an FPGA application on an FPGA compute node.

FIG. 3B is a block diagram of an alternative embodiment of an FPGA application on an FPGA compute node connected with a control FPGA.

FIG. 4A is a block diagram of an FPGA component.

FIG. 4B is a block diagram of FPGA source code file.

FIG. 5A is a block diagram of an FPGA layout having a plurality of FPGA components arranged serially.

FIG. 5B is a block diagram of an FPGA layout having a plurality of FPGA components arranged in parallel.

FIG. 5C is a block diagram of normal microprocessor execution of instructions.

FIG. 5D is a block diagram of a microprocessor execution with event monitoring.

FIG. 5E is a block diagram of an FPGA based processor execution time with event monitoring.

FIG. 6 is a block diagram of an FPGA application development module.

FIG. 7 is a block diagram of an FPGA compilation module.

FIG. 8 is a block diagram of a trusted deployment module.

FIG. 9 is a block diagram of node to node communication within an FPGA application using a plurality of changeable protocol features.

FIG. 10 is a block diagram of an example FPGA system.

FIG. 11 is a block diagram of an I/O node for use in an FPGA system.

FIG. 12 is a block diagram of a reconfigurable compute node for use in an FPGA system.

FIG. 13 is a block diagram of a common memory node for use in an FPGA system.

FIG. 14 is a block diagram of an exemplary FPGA application employing two four node chassis.

FIG. 15 is a block diagram of an exemplary FPGA application employing one thirty-two node chassis.

FIGS. 16A-16E are schematic block diagrams of various protocols that can be utilized within an FPGA application.

### DESCRIPTION OF THE PREFERRED EMBODIMENTS

The FPGA provides relative flexibility and processing speed once appropriately configured. That said, configuration of these devices must be constantly coordinated in order to carry out this processing. Currently, developer access to source code for circuit development on FPGAs is limited to either open source or larger up-front licensing costs, paid either per developer seat or per application. At the same time, enterprise application developers seek to utilize and incorporate as many durable and performant components as possible in to their applications to both speed their time to market and reduce the overall amount of code that they have to build and maintain. While FPGA processors have been in existence for some time, FPGAs have commonly been used in specialty computing or embedded computing devices due to large development costs.

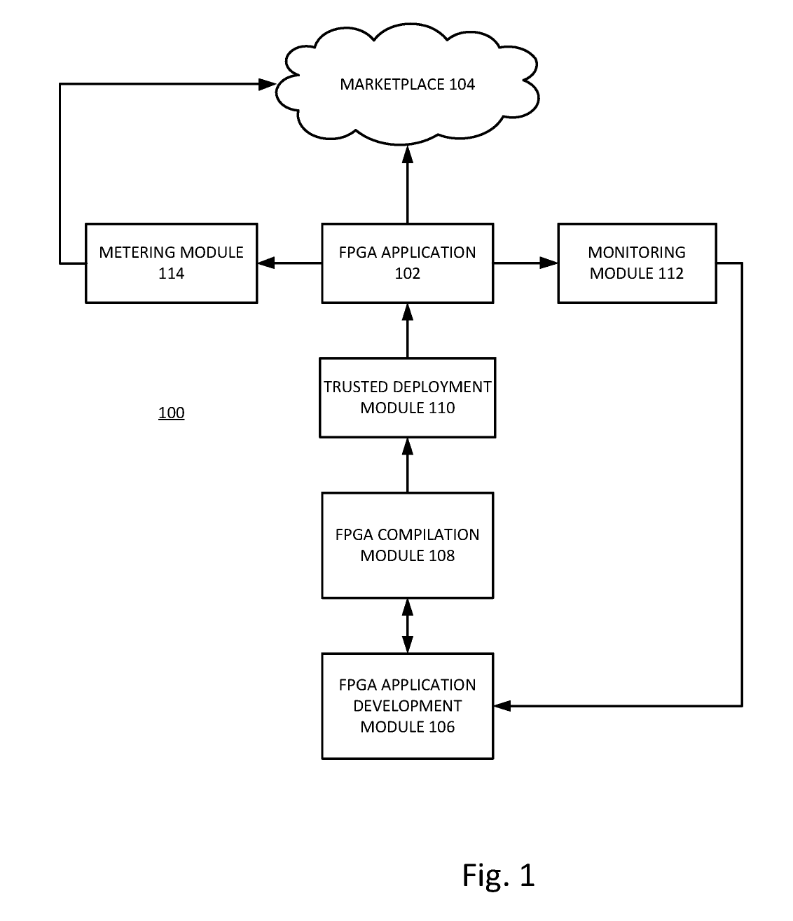

FIG. 1 is a schematic diagram of a FPGA PaaS environment 100 including several modules for building and deploying an FPGA application 102 deployed within a marketplace 104 that can facilitate compensation based on development, compilation and deployment of the FPGA application 102. FPGA application 102 is built using a suitable application development module 106 that can include various tools used by a developer as will be discussed below. After assembling of source code using development module 106, an FPGA compilation module 108 can be used to compile the source code. The FPGA application 102 can be scaled for enterprise applications such that multiple FPGA compute nodes, multiple memory nodes, FPGA switches, and multiple I/O nodes coordinate together in an enterprise supercompute platform to provide improved security and performance as compared to current systems. In one embodiment, the entire FPGA application 102 executes computing, storage, switching, and networking without the use of an operating system.

In one embodiment, when ready for deployment, FPGA compilation module 108 produces a multi-component application package, including one or more bitstreams and stream connection information specifying connection between streams within the FPGA application 102. The application package can be protected and encrypted in order to generate a secure deployment by a trusted deployment module 110. Trusted deployment module 110 uses the application package to deploy the FPGA application 102 on one or more servers as specified within the development module 106. In one embodiment the trusted deployment module 110 can utilize one or more management FPGAs to communicate with and deploy the FPGA application 102. The one or more servers can be within a single data center or deployed across multiple data centers as desired.

The FPGA application 102 can be implemented using FPGA processors without an operating system. Accordingly, any cyber-attack surface for the FPGA application 102 can be greatly reduced or eliminated. To that end, a compiler using standard high level language(s) or graphical user interface (GUI) based programming techniques that are familiar to developers can be used.

In one embodiment, the FPGA application 102 does not require a host microprocessor, but rather utilizes FPGAs. In contrast, current FPGA based processing elements, such as Microsoft's Catapault boards or various cards build by Altera or Xilinx are treated as accelerators to microprocessors in one form or another, still leaving the system vulnerable to traditional attacks. Using exclusively FPGA based computational elements in FPGA application 102 executes only code that is instantiated in data flow circuitry in the FPGA processor(s). Functions that can be exploited by an attacker are thus reduced or eliminated, in contrast to a microprocessor with exploited functions in operating system code.

A suitable compiler to develop FPGA application 102 can accept standard high level languages, such as C, and converts the high level language into data flow graphs that can be implemented in one or more FPGA processors without any of the FPGA application 102 being required to reside on a microprocessor. The high level language input to the compiler can also be generated through the use of a GUI. While many “C to Gates” type FPGA compilers exist today, such as those produced by Impulse Accelerated Technologies, these compilers do not enable an entire software application to be implemented using only an FPGA processor, or only a collection of FPGA processors. Rather, these applications use a microprocessor host to configure the FPGA, decide what data the FPGA will receive and perform application interface management. By combining the use of only FPGA processors for computation and a compiler capable of generating stand-alone applications for the FPGA processors, attack surfaces for the application can be reduced.

As used herein, an FPGA application includes any computer program that performs data processing where most or all of the data processing is performed on reconfigurable hardware such as an FPGA processor. In one embodiment, the run-time environment is entirely FPGA based without an operating system utilizing a mix of reconfigurable compute nodes, reconfigurable switches, reconfigurable common memory nodes, and reconfigurable I/O nodes. In another embodiment, in a run-time environment, the FPGA application can utilize a mix of microprocessors, with an operating system or compiled as machine code without an operating system, reconfigurable compute nodes, reconfigurable common memory accessible by the processors and switch modules in various combinations as specified. Other elements can be used in the FPGA application 102, such as stream protocols, stream data sources, I/O connectors (providing connection along an internal wire), I/O agents (providing connection to an external system, components of code blocks and composite components formed of multiple components of code blocks.

Within the FPGA application, the processors can operate independently or selectively as desired. In some embodiments, the FPGA application 102 includes one or more ingress points (portions of the FPGA application that receive input messages external to the FPGA application), one or more egress points (portions of the FPGA application that communicate output messages externally from the FPGA application), one or more reconfigurable compute nodes (e.g., physical FPGA's that process data), one or more memory nodes (e.g., persistent physical memory, non-persistent physical memory) accessible to the processing nodes whereby the processing nodes read and write data to the memory nodes and one or more switches including executable logic for routing and communicating among the processing and memory nodes. In some embodiments, the compute nodes can include microprocessors.

In one embodiment, the FPGA application 102 utilizes an event processing system that includes event generators and event consumers. Components of the FPGA application 102 can generate or initiate events within this event processing system and presented to a plurality of event streams within the FPGA application 102 and moreover events can be recorded as one or more event records. Event records, in one embodiment, either in conjunction with a secure hardware element (e.g., a trusted platform module (TPM)) or independent therefrom, can produce event records based on a zero-knowledge block chain architecture. As such, independent parties with knowledge of a key to the event record could later attest to a particular event being true or false.

During operation, a monitoring module 112 can further be employed to monitor various metrics of the deployed FPGA application 102. These metrics can include response times, usage of particular components, etc. The metrics can be used to analyze performance of the FPGA application 102 and, based on the analysis, update the source code for the FPGA application 102 using application development module 106. As discussed in more detail below, the monitoring module 112 collects information emitted from a monitoring circuit in parallel with actual processing conducted by the FPGA application 102 without incurring any performance penalty to the FPGA application 102. Collectively, the monitoring module 112 can be used to perform load balancing, utilization calculation of various components associated with the FPGA application 102 and other heuristic measures in order to optimize deployment of the FPGA application 102.

Additionally, a metering module 114 can be used to conduct metering of the deployed FPGA application 102. As discussed in more detailed below, metering module 114 collects information emitted from a metering circuit in parallel with actual processing conducted by the FPGA application 102 without incurring any performance penalty to the FPGA application 102. Metering events produced by metering module 114 are associated with each deployed FPGA application 102 and produce specific usage counts. Usage counts may be processed using a metering circuit to produce an output as desired. In one embodiment the metering module 114 operates in parallel on the same FPGA circuit with processing blocks of the FPGA application 102.

In one embodiment, metering events are routed to a specific egress point specified in the FPGA application 102 and collected by the metering module 114 for appropriate aggregation and use in billing in real-time (e.g., by creating a metering event record). In another embodiment, metering records may be formatted and communicated to a billing system (e.g., a SaaS billing provider like Zuora, a cloud provider like Amazon Web Services or Microsoft Azure). In another embodiment, other methods of transporting metering records (e.g., a GNU privacy guard (GPG) encrypted email or equivalent) can be used. Transporting of the records enables systems that are not directly connected for various reasons (e.g. security, connectivity) to be sent remotely to the metering module 114. In one embodiment, the metering events that can be billed by the PaaS platform and allocate the apportionment and distribute payment for each unique compensation obligation.

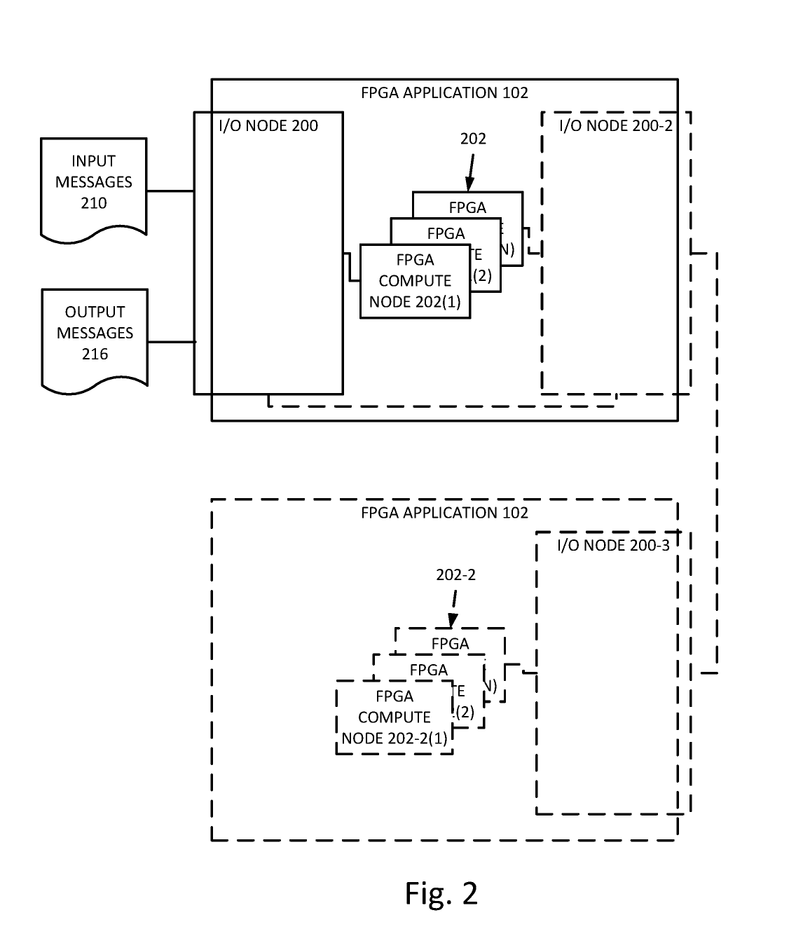

FIG. 2 is a block diagram of components of the FPGA application 102 according to one embodiment. FPGA application 102 includes an I/O node 200 and one or more FPGA compute nodes 202 (shown as separate FPGA compute nodes 202(1-N)). The FPGA compute nodes 202(1-N) can be spread across an entire enterprise, comprising multiple data centers, multiple chassis and multiple nodes within a chassis. In operation according to one embodiment, input messages 210 are received by the I/O node 200 which can perform message interpretation, load balancing, high availability, durability and stream routing to distribute streams to the FPGA compute nodes 202. I/O node 200, in one embodiment, comprises one or more ingress points to the FPGA application 102 as well as one or more egress points from the FPGA application 102. The FPGA compute nodes 202 perform stream processing on the received input messages 210 using FPGA compute nodes as discussed below and provides output data to the I/O node 200. I/O node 200 then transmits output messages 216. Each of the FPGA compute nodes 202(1-N) can be identical in one embodiment (e.g., to provide a high availability solution) or include separate processing tasks for the FPGA application.

In one embodiment, FPGA application 102 is programmed to perform networking functions, and directly receives network packets (e.g., Ethernet packets) as input messages 210 via I/O node 200, and FPGA compute nodes 202(1-N) implement a business application including business rules in hardware. In one form of this embodiment, the entire business application stack is implemented within reconfigurable compute nodes, from the communications (e.g., Ethernet) layer up to the business application of the FPGA application 102, including the I/O node 200 and FPGA compute nodes 202. That is to say, excluding translation from an incoming message to a format readable by configurable processor and translation from the format readable by the reconfigurable processor to an outgoing message format, the reconfigurable processors perform all processing within the FPGA application 102 without an operating system managing resources. In one specific embodiment, the compute nodes form the primary computing function for the FPGA application 102 without the use of an operating system managing the reconfigurable processor or any other hardware resources of the FPGA application 102. That is to say that the FPGA application 102 operates independent from any operating system. In another embodiment, the networking functions and business application may include separate processing elements deployed in any manner across multiple reconfigurable compute nodes and multiple cards. In a further embodiment, I/O node 200 contains a portion of the networking functions and/or business functions for FPGA application 102. In yet another embodiment, compute nodes 202 may use a single reconfigurable compute node or may use reconfigurable hardware other than a reconfigurable processor. In yet another embodiment, compute nodes 202 may use reconfigurable hardware in cooperation with a microprocessor. In one embodiment, I/O node 200, acts as a translator of network packets to binary information in order for the FPGA compute nodes 202 to process the binary information. Communication among the FPGA compute nodes 202 can be governed by a communication protocol (e.g., also using binary information) as discussed below. The I/O node 200 can act as a translator of binary information processed by the FPGA compute nodes 202 to network packets as desired.

FPGA application 102, according to one embodiment, provides a high availability solution for an enterprise. For example, FPGA compute nodes 202 can perform redundant work so that if one or more of the FPGA compute nodes 202 fail, the FPGA application 102 is still able to provide an answer or response to messages sent to the FPGA application 102. In one implementation, I/O node 200 according to one embodiment will simultaneously provide input streams to multiple FPGA compute nodes 202, and some or all of the FPGA compute nodes 202 will perform identical computing on the received input streams. Each of these FPGA compute nodes 202 will then provide an output stream to I/O node 200. I/O node 200 receives the output streams and identifies a single one of the output streams (e.g., using a consensus algorithm) to provide as output message 216. In this manner, FPGA application 102 provides high availability and increased reliability of responses.

It is noted that FPGA compute nodes 202 may be within a single chassis or spread across multiple separate and distinct chassis, and any given one of the chassis may include more than one I/O node 200 and any number of FPGA compute nodes 202. For example, one chassis may implement I/O node 200 and a single FPGA compute node 202, such that the I/O node of the chassis can decide to route input streams to FPGA compute nodes 202 within the chassis, as well as to other FPGA compute nodes 202 in one or more other chassis that implement a portion of the processing for FPGA application 102. As illustrated in dashed lines of FIG. 2, the FPGA application 102 can be scaled to include a second I/O node 202-2 and a third I/O node 202-3 that communicate directly with one another in order to use processing of a different set of FPGA compute nodes 202-2.

Various communication channels can be used to communicate within the FPGA application 102 (e.g., within and between separate FPGA compute nodes 202) such as an Ethernet or InfiniBand I/O node, a bidirectional data bus including streams of binary data from a separate reconfigurable hardware node, an intra-chassis communication connection (e.g., to a separate node within a chassis), an inter-chassis communication connection (e.g., an optical link) and others. In one embodiment, FPGA application 102 is constrained to an FPGA compute node 202 on a single reconfigurable integrated circuit chip (e.g., a Field Programmable Gate Array (FPGA)). In a further embodiment, FPGA application 102 can be distributed across multiple integrated circuit chips, multiple nodes (e.g., a printed circuit board containing one or more circuits) within a chassis, and/or multiple chassis connected via a communications channel such as Ethernet, InfiniBand, or a direct optical link.

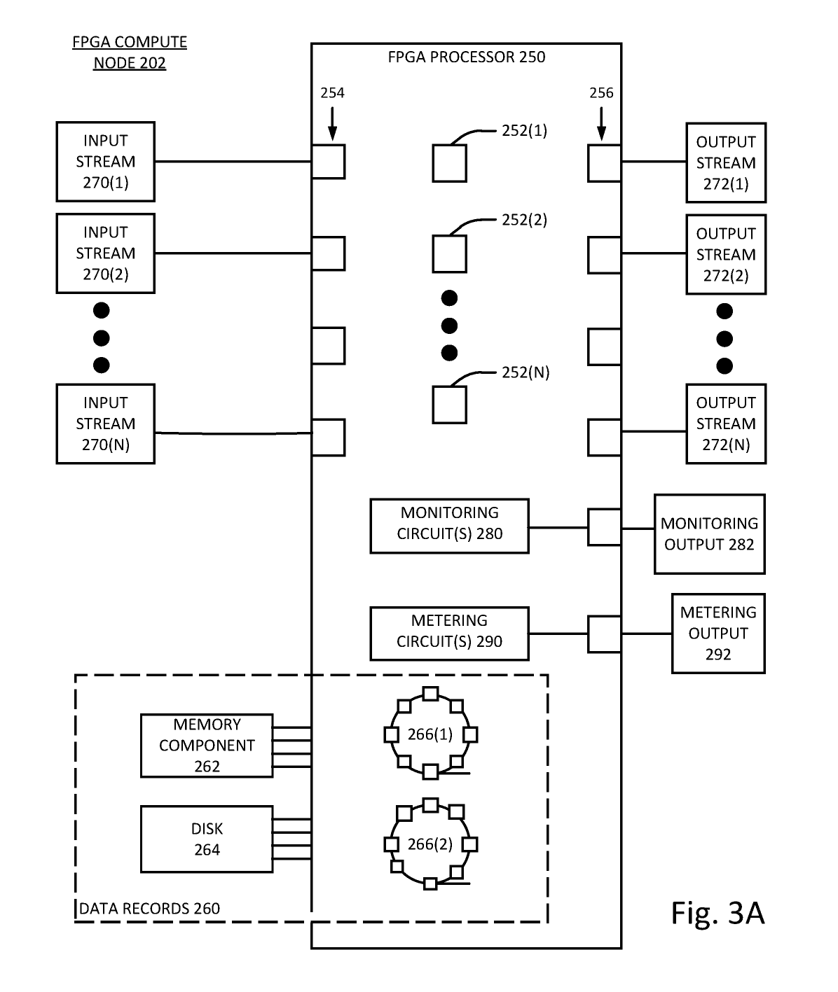

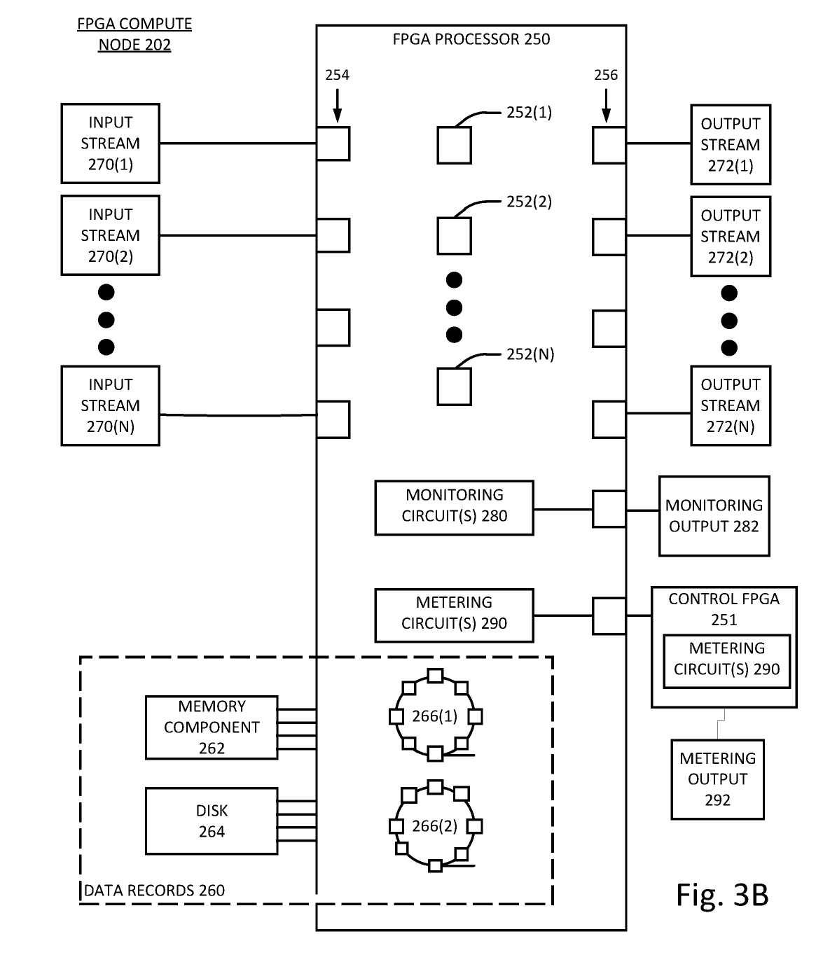

FIG. 3A is a block diagram of an exemplary FPGA compute node 202 that can be embodied on a suitable processing platform as will be discussed below. In one embodiment, FPGA compute node 202 operates without an operating system and is formed of a plurality of logic blocks and interconnections (e.g., stream connections) between logic blocks configured to run applications directly on one or more FPGA compute nodes. As illustrated herein, FPGA compute node 202 includes an FPGA processor 250 formed of a plurality of FPGA components 252 (shown as any number 1-N) that form a plurality of circuits to receive data from an ingress assembly 254 (e.g., formed of one or more ingress points), process the data and output or transmit the data to an egress assembly 256 (e.g., formed of one or more egress points).

In one embodiment, the FPGA processor 250 is a physically discrete integrated circuit including multiple reconfigurable hardware gates. In other embodiments, the FPGA processor 250 includes multiple physically discrete integrated circuits connected to one another through various communication links. In one embodiment, the FPGA components 252 process the data deterministically. The FPGA components 252(1-N) process data using data records 260 that are directly accessed by the FPGA processor 250 (e.g., memory component 262, disk 264) or stored natively within the FPGA processor 250 (e.g., in memory loops 266). The ingress assembly 254 and egress assembly 256 access one or more input streams 270, such as those received from I/O node 200 (FIG. 2). In particular, the ingress assembly 254 receives data from the input streams 270 and the egress assembly 256 provides data to one or more output streams 272. Output streams 272 are then sent to I/O node 200 (FIG. 2).

In one embodiment, one or more of the FPGA components 252(1-N) can be compiled to be associated with one or more monitoring circuits 280 that operate in parallel with the FPGA components 252(1-N) to track one or more metrics associated with the FPGA components 252. The monitoring circuits 280 provide a monitoring output 282 that can be aggregated across each of the FPGA compute nodes 200 to provide monitoring data (e.g., aggregated and/or real-time) of the FPGA application 102.

In yet a further embodiment, each of the FPGA components 252(1-N) can be compiled from separate sources such that one or more FPGA components can be developed separately, which are then compiled and deployed onto the FPGA processor 250. In such instances, the FPGA compilation module 108 (FIG. 1) can add one or more metering circuits 290 to the FPGA processor 250. The metering circuits 290 are programmed with FPGA component identifiers for metering of the FPGA components 252 as desired. In one embodiment, the metering circuit 290 includes a time event emitter that can produce time based metering events for FPGA components 252 in the FPGA compute node 202. The metering circuits 290 can further include an aggregation module to develop metering records, summarize the records and produce a metering output 292 for FPGA components 252. The metering output 292 is processed by the metering module 114 to determine compensation based on operation of the FPGA components 252. For example, FPGA component 252(2) may include a usage rate of $0.00001 per use, $1.00 per GB processed, or $0.10 per hour. Metering circuit 290 can thus include a corresponding counter that determines a number of times that FPGA component 252(2) is used. This number can then be output to the metering output 292. Metering can be performed for any and all FPGA components 252 and using any unit of measure.

In one implementation, the monitoring circuit 280 and metering circuit 290 directly interface with pins of a discrete FPGA integrated circuit that directly provides the monitoring output 282 and metering output 292, respectively, along a wire coupled with the pins. To this end, a dedicated line can be established with the FPGA processor 250 to collect the monitoring output 282 and metering output 292 separate from operation of other components of the FPGA application 102. In yet a further implementation, illustrated in FIG. 3B, the metering circuit 290 directly routes events to a secondary FPGA processor 251. The FPGA processor 251 includes circuitry for the metering circuit 290. In one example, the metering circuit 290 includes a buffer to collect events by execution of one or more of the FPGA components 252. From the metering circuit 290 in the FPGA processor 251, metering output 292 is produced as discussed above.

Accordingly, in one embodiment for using metering circuit 290 to generate metering output 292, a method includes receiving a first digital bit stream of data to a plurality of circuits. The plurality of circuits are generated from a plurality of code blocks. In parallel with processing the first digital bit stream of data through the plurality of circuits, a usage value is generated that is indicative of execution of at least one of the plurality of circuits consuming the first digital bit stream. A second digital bit stream is transmitted indicative of the one or more usage values.

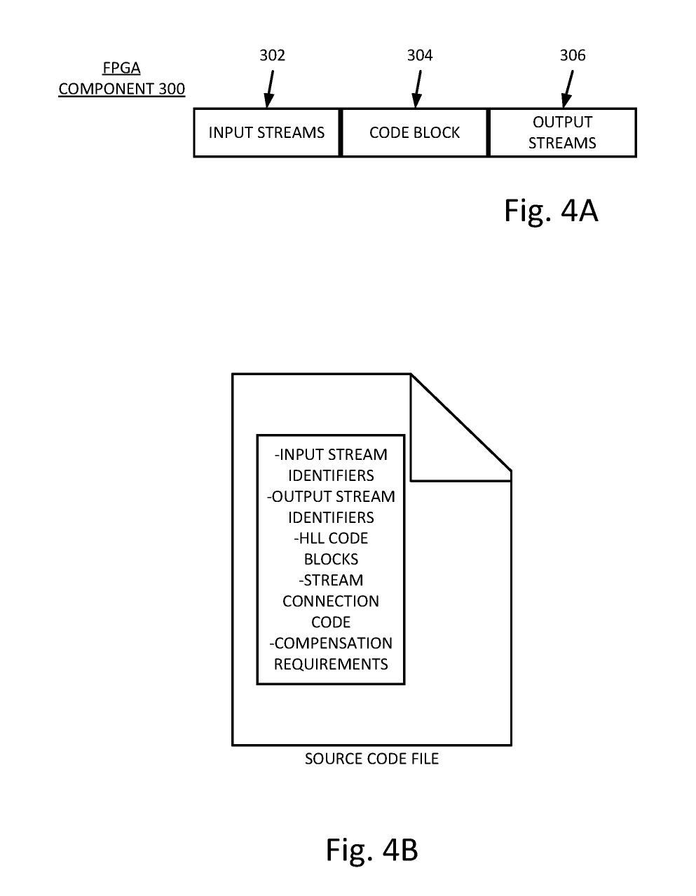

As used herein and schematically illustrated in FIG. 4A, an exemplary FPGA component 300 is a data process that defines one or more input streams 302, a code block 304 (e.g., defined by source code, compiled and configured onto a reconfigurable hardware unit) that defines operations to be performed on the one or more input streams, and one or more output streams 306. Within FPGA application 102, input streams 302 and output streams 304 include various forms of information for identifying aspects of the streams. For example, the input streams 302 and output streams 304 can include a type (e.g., a payment stream, a token stream, a key value pair), a unique identifier to distinguish streams within the FPGA application 102, a width and other information useful in processing streams. When an FPGA component 252 is positioned adjacent another FPGA component, that FPGA components 252 includes reconfigurable hardware that conveys the output stream of one FPGA components to the input stream of one or more subsequent FPGA components.

In one embodiment, the input streams 302 include stream protocol information for receiving information from a corresponding output stream and output streams 304 include stream protocol information for communicating to a corresponding input stream. For example, an output stream within an application can include information that indicates an adjacent input stream is located within the same FPGA processor and, as such, can include a control bit or other indicator indicating that no specific protocol is needed to transmit a result to the adjacent input stream. In another embodiment, an output stream can include information that an adjacent input stream is located on another FPGA processor, within the same chassis and communicated through a switch within the chassis. In such a situation, the output stream can utilize an intra-chassis protocol that governs communication between streams within the same chassis. In still a further embodiment, an output stream can include information that indicates an adjacent input stream is located on a separate chassis. Accordingly, the output stream can include specified stream protocol information as well as encryption features (e.g., using IPsec or an arrangement of encryption cyphers) to communicate the stream across Ethernet. In one embodiment, complex addressing techniques can be used, for example by denoting addresses with information pertaining to chassis, node and direct memory address in a memory access operation. In yet a further embodiment, an enterprise level stream protocol layer can be utilized in conjunction with stream protocol information for communication between input and output streams that span across an enterprise system, for example to a separate circuit, node, chassis, data center or the like. The enterprise stream protocol layer is useful in establishing a secure enterprise infrastructure.

FIG. 4B is a schematic diagram of a source code file for an FPGA component. The source file includes several informational elements that are ultimately compiled and formed into direct execution logic. In one embodiment, the direct execution logic is an enterprise level application containing logic that spans across nodes of an enterprise supercompute platform. Example elements in the source code file include input stream identifiers, output stream identifiers, high level language or hardware description language code blocks, data flow description language, stream connection code that adheres to connection protocols for connecting adjacent streams, compensation requirements for developers of source code and other informational elements. During compilation, the input stream and output stream identifiers are utilized to prevent conflict in naming across an application so as to have unique stream identifiers for each stream (e.g., across an enterprise). For example, if a particular source code file is used in multiple locations throughout an application, unique identifiers to each stream are assigned during application development (e.g., by chassis and/or node). The data flow description language and stream connection code are used to connect adjacent streams and further prevent streams that do not provide an output to the application. For example, if a particular code block includes four output streams, the stream connection code can ensure that there are four corresponding connections for the four output streams. The data flow description language can be used to generate stream connection code upon compilation of the FPGA application. The compensation requirements can be set by a developer and, upon compilation and deployment, form direct execution blocks that operate in parallel with logic of the application to determine an amount of use and compensation of the application logic.

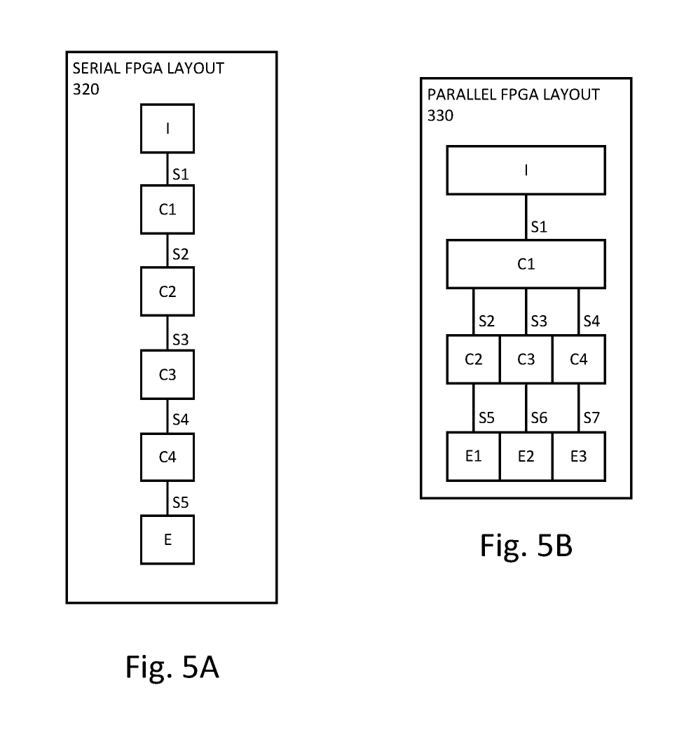

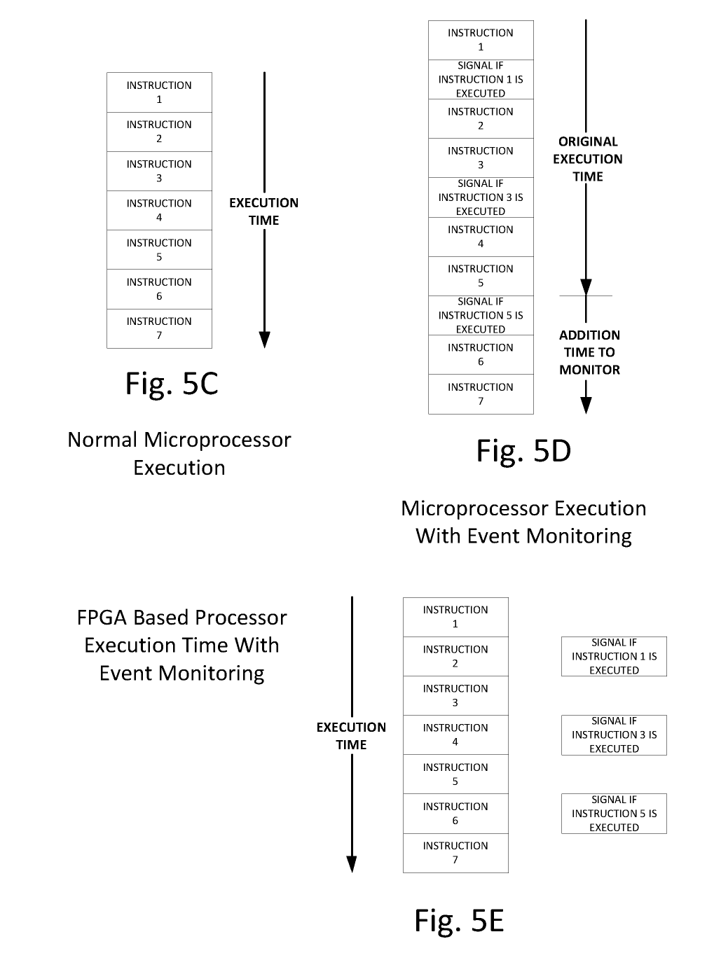

Within FPGA application 102, a plurality of FPGA components can be arranged in sequence and/or in parallel. For example, FIG. 5A is a schematic block diagram of an example FPGA layout 320 including an ingress I, egress E and a plurality of FPGA components C1-C4 arranged in a sequence (i.e., serially) between the ingress I and egress E. FPGA layout 320 further includes a plurality of streams S1-S5 positioned between the FPGA components C1-C4 to provide connection between adjacent microcircuit segments. In particular, the streams S1-S5 convey data from a corresponding output stream of a first FPGA component to a subsequent input stream of a second FPGA component. In particular, stream S1 conveys data from the ingress I to the input of FPGA component C1, stream S2 conveys data from an output of FPGA component C1 to an input of FPGA component C2, stream S3 conveys data from an output of FPGA component C2 to an input of FPGA component C3, stream S4 conveys data from an output of FPGA component C3 to an input of FPGA component C4, stream S5 conveys data from an output of FPGA component C4 to egress E. As discussed herein with respect to FPGA compilation module 108, code for the stream S1-S5 can automatically be compiled based on input streams 302 and output streams 306 for a specified FPGA component. Additionally, the streams S1-S5 can include stream protocol information for communication between components that may be on the same FPGA, on the same node, on a different node within the same chassis or on a separate chassis altogether. The FPGA compilation module 108 can further identify whether adjacent components include uniform variables between input and output streams. For example, with respect to FIG. 5A, the FPGA compilation module 108 can determine that component C1 includes four output streams and component C2 includes a uniform number of four input streams. In the event the FPGA compilation module 108 determines non-uniformity in the FPGA application 102, an error message can be generated.

FIG. 5B is a block diagram of an example FPGA layout 330 including an ingress I, an egress E and a plurality of FPGA components C1-C4, with FPGA components C2-C4 arranged in parallel. In particular, stream S1 conveys data from the ingress I to the input of FPGA component C1. Streams S2-S4 then convey data from a corresponding output of FPGA component C1 to an input of FPGA components C2-C4. FPGA components C2-C4, upon receiving data on their respective inputs, operate to process the data in parallel (e.g., during the same clock cycle of the other FPGA components). Streams S5-S7 then convey data from a corresponding output of FPGA components C2-C4 to egresses E1-E3. It is worth noting that the components in layouts 320 and 330 can be connected together during compilation of an FPGA application such that ingress and egress points are established for the FPGA application as a whole dependent upon which components are configured to accept communications from external sources and which components are configured to communicate to external destinations.

In the context of metering execution of any of the FPGA components C1-C4 as discussed above with respect to FIG. 3, event monitoring can be performed in parallel with operational instructions. In FIG. 5C, an example application comprising instructions (or alternatively instruction sets) 1-7 is schematically illustrated. In current microprocessor approaches, the instructions are executed sequentially, such execution performed in an execution time. If a developer desired to collect information for each instruction (or any number of the instructions) that was executed, as illustrated in FIG. 5D, the developer would have to insert signal instructions within the instruction sequence. In the example illustrated, signals would be generated when instructions 1, 3 and 5 are executed. The time to generate this signal is added to the execution time. In contrast, as illustrated in FIG. 5E, the signals generated for instruction generation of signals 1, 3 and 5 are done in parallel with the execution of instructions 1-7, causing execution time to be the same as that of FIG. 5C

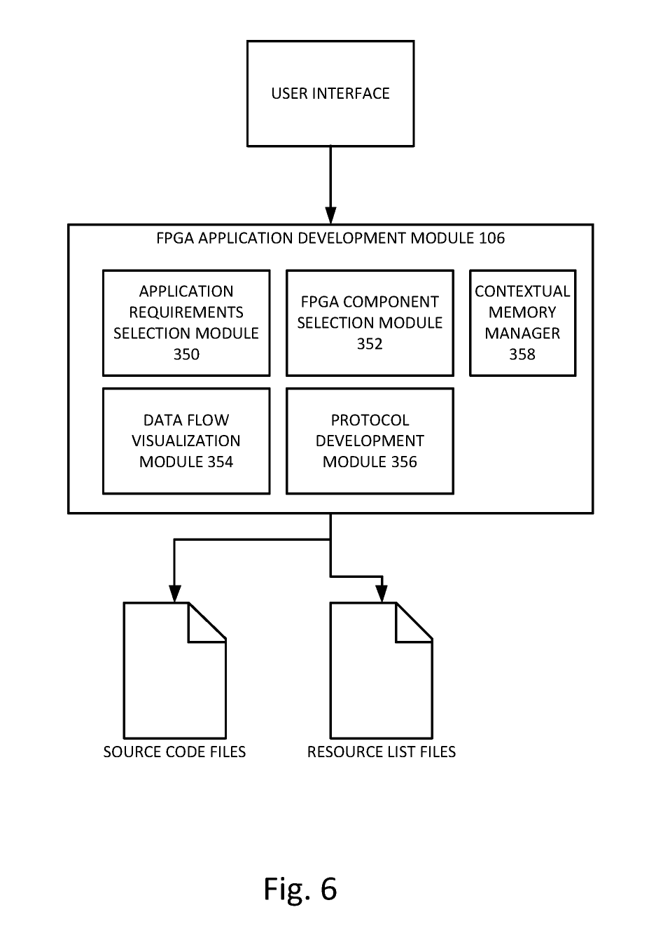

With the above understanding of an FPGA application in mind, FIG. 6 is a block diagram of FPGA application development module 106. The development module 106 utilizes several tools to develop FPGA applications, for example accessed through a user interface 340 (e.g., command line, GUI). One tool is an application requirements selection module 350, which can include an interface to select various parameters associated with an FPGA application, such as availability specifications, deployment specifications, memory specifications, attestation specifications, service level agreement specifications, I/O node specifications and others. These specifications aid in determining a number of nodes, types of nodes, chassis, security features and other parameters of a deployed FPGA application. For example, it may be determined that an FPGA application can utilize two chassis with load balancing for normal operation of the application and one chassis for disaster recovery. From the application requirements, a resource list can be generated identifying the components and types of components to be used. The list can include a list of chassis, compute nodes for each chassis and memory nodes for each chassis. The application package can include direct execution logic (e.g., in the form of bitstreams) for each of the compute nodes in the FPGA application.

An FPGA component module 352 allows a developer to select FPGA components (developed either internally or by third parties) that will be utilized within the FPGA application 102. In one embodiment, third party developers can publish a functionality description of FPGA components and specify licensing fees for use of the FPGA components in an FPGA application. The fees can be based on a type of deployment indicating a debug, hardware simulation, or FPGA application deployment. In another embodiment, developers can publish a functionality description of FPGA components and specify licensing fees based on processing counts or use per time period or any unit of measure. In another embodiment, licensing fees can be specified per developer seat. Upon compile, a metering circuit is added to the FPGA application to calculate the compensation as specified.

A data flow visualization module 354 allows a developer to visualize data flow within an FPGA application. Using the visualization module 354, the developer can gain an understanding of the overall scope of an FPGA application and what components are utilized in what location, whether the location is on a particular FPGA processor, within a particular chassis or other location. For example, in one embodiment, the visualization module 354 can display an application flow that illustrates all ingress points for FPGA application 102 (e.g., by denoting the ingress points on a left-hand column or top of a graphical user interface). For example, the ingress points can be denoted with a particular name such that a developer can readily identify external connection points to their respective ingress points. The visualization module 354 can then further illustrate application streams that connect with the ingress points and/or managed memory for read operations that connect to the ingress points. In another embodiment, the visualization module 354 displays data records captured in a test run of the FPGA application 102. The visualization module 354 enables a user to step through actual captured data flow in a time sequence, interact and inspect the data at each stage of operation of the FPGA application 102 processing the test data. Various rule frameworks can further be illustrated that process inbound messages received from the ingress points of the FPGA application 102. The visualization module 354 can further display output streams, managed memory for write operations and application egress points for the FPGA application 102. During operation of the FPGA application, the visualization module 354 can be updated in real-time to provide an understanding as to how the FPGA application 102 is performing.

In a further embodiment, the application development module 106 can include a contextual memory manager 358, where a developer can indicate how memory is managed within the FPGA application 102. For example, the contextual memory manager 358 can specify access to data stored within memory devices (e.g. managed memory data set) that are used by the FPGA application 102. In one embodiment, certain components (or nodes) can only be granted read access to this data. In alternative embodiments or in addition thereto, the contextual memory manager 358 can be used to indicate memory access control within direct execution logic when an application is compiled such that only direct execution logic has access to memory, which can greatly increase security within FPGA applications. For example, in an enterprise application with several common memory data sets, enabling a single component to write to a single managed memory data set can enable data integrity for the application. In one embodiment, the direct execution logic enforces the access rights to the common memory data sets.

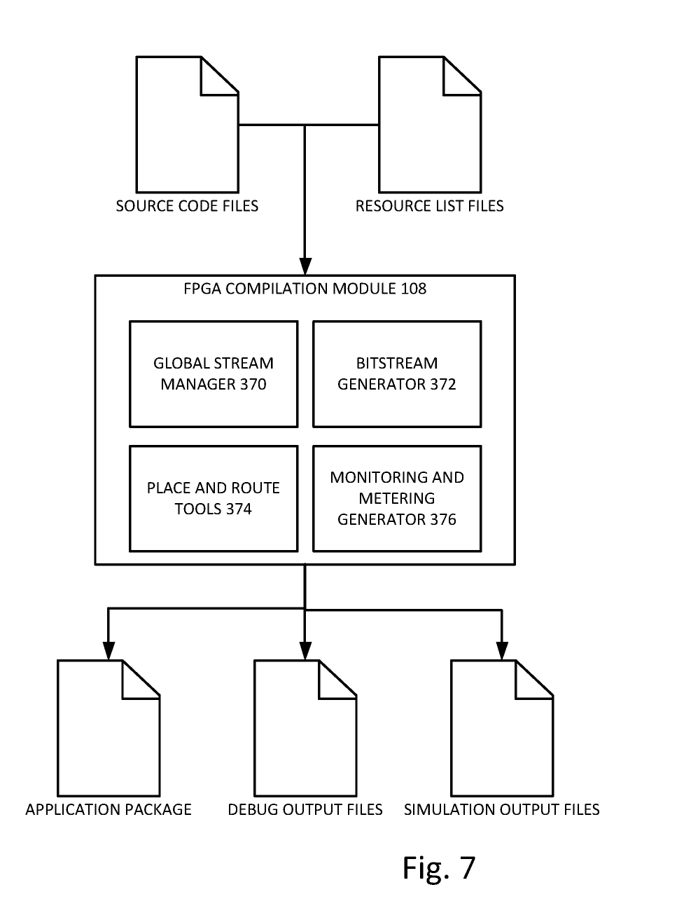

With reference additionally now to FIG. 7, FPGA compilation module 108 is illustrated, which uses several elements such as a global stream manager 370, bitstream generator 372, place and route tools 374 and monitoring and metering circuit generator 376. The global stream manager 370 uses stream identifiers from source code files for the application and generates a namespace for each stream such that each stream has a unique identifier. As such, duplication of stream identifiers within the application is avoided. In some instances, FPGA compilation module 108 generates a bitstream using bitstream generator 372 for use with a specified FPGA or specific blocks in the FPGA application.

In instances where FPGA application 102 utilizes multiple compute nodes, an application package can be generated such that the application package identifies bitstreams for each compute node in the application. In this case, the FPGA the compilation module 108 receives source files as indicated by development module 106 and uses the hardware version of libraries associated with bitstream generator 372 of FPGA compilation module 108 and invokes the FPGA place and route tools 374 in order to generate one or more FPGA bitstreams. The bitstream(s) generated is included in an object file by the compilation module 108. The FPGA compilation module 108 produces an application package, which can include one or more bitstreams (direct execution logic) for each of the compute nodes in the FPGA application.

The FPGA compilation module 108 accepts source files and resource list files to provide an overview of the FPGA application to the developer. The source files can be from standard libraries, developed by third parties and/or internally developed. The compilation module 108 can aggregate source files written in C and/or C++ and other low-level virtual machine (LLVM) supported languages as well as Verilog. As such, the developer can access low-level hardware capabilities: definition and creation of processor hardware from within high-level programming languages. This level of control over compute and memory access greatly facilitates achieving high computational performance. In one embodiment, the compilation module 108 can import code written in different languages such as low level virtual machine (LLVM) languages, Intermediate Language (IL) in VB.NET and others (e.g., Java, C#, Swift). Upon import of this code, a developer can create composite data flow applications using a graphical user interface designating components visually or with a flow language. As such, a developer can optimize execution of an application with parallel or serially specific segments upon compilation of an FPGA application 102.

The compilation module 108 can include software that will interpret source files (e.g., written in Verilog, C, C++) and create direct execution logic for the FPGA processors in an application. The compilation module 108 extracts maximum parallelism from the code and generates pipelined hardware logic instantiated in the FPGA compute node. In one embodiment, the compilation module 108 includes a number of different libraries that create direct execution logic formed into one or more bitstreams that form an application package.

The compilation module 108 also provides users with the ability to emulate and simulate compiled code in “debug mode” or simulation (“sim mode”). Debug/Sim mode compilation allows the user to compile and test all of their code on the CPU without invoking the FPGA place and route tools 374. Debug/Sim mode can also provide loop performance information, which enables accurate processor code performance estimation before FPGA place and route.

The monitoring and metering generator 376 generates direct execution logic indicative of use for specified source files that are from third party developers that indicate compensation within the source files, such as for per use, per time period, per simulation use, per simulation time period, etc. In addition, the generator 376 generates direct execution logic that can indicate various monitoring statistics valuable to the developer, whether the statistics are generated with respect to test data or during actual deployment of the application. In any event, the compilation module 108 operates to position monitoring and metering direct execution logic in parallel with execution of application logic to avoid any performance penalty.

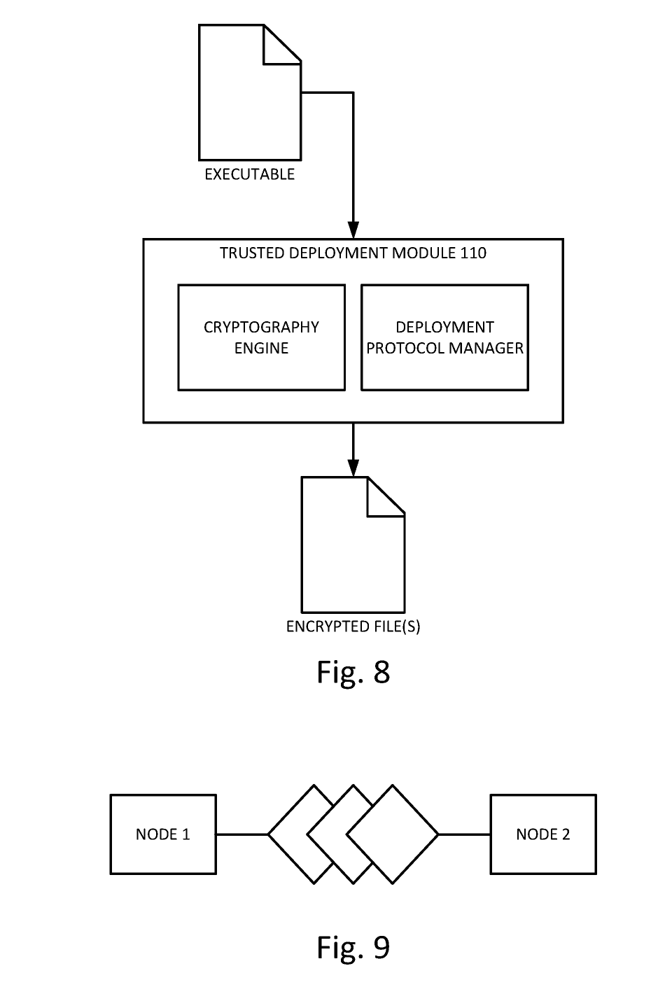

FIG. 8 is a block diagram of trusted deployment module 110, which accepts an application package from the compilation module 108. The trusted deployment module 110 uses a cryptography engine 380 and deployment protocol manager 382. The cryptography engine 380 encrypts the application package such that the encrypted file can be sent to a remote system for deployment. In combination, the deployment protocol manager 382 can manage keys and other secure elements to ensure that the file encrypted by the cryptography engine 380 remains secure and only deployed to a trusted destination. Ultimately, one or more encrypted bitstreams can be sent to remote systems for operation as desired. When multiple compute nodes are employed, the deployment protocol manager 382 can govern what portions of the application are deployed to specified nodes used to operate the FPGA application 102.

In order to efficiently and securely process information between nodes in FPGA application 102, a one way, asynchronous communications protocol can be utilized. FIG. 9 is a schematic block diagram of communication between node 1 and node 2 using a plurality of changeable protocol features (schematically shown as diamonds) that govern the communication between nodes. Example protocol features include encodings, wrappers, cyphers, cypher patterns, keys, algorithms, and permutations and transmitting a message from a sender (e.g., node 1), the protocol features can dictate that a message include a sender identifier, a signature, encryption pattern, one or more keys, a destination identifier, a number and type of security frameworks, cyphers, algorithms, etc. used given the destination. In receiving and decoding a message at the receiver, the receiver (e.g., node 2) can evaluate contents of the message to verify adherence to the changeable protocol features of the received message. For example, the receiver can verify the signature, encryption, format, etc. to determine whether the message is from a trusted source and content within the message is safe to process.

For a particular FPGA application, any number of different protocols, cyphers, keys, algorithms, and perpetuations can be used with varying changeable protocol features to establish varying levels of security. For example, a first protocol can be used when node 1 is external to the FPGA application and node 2 is part of the FPGA application. For example, such communication can be encrypted. In another example, where node 1 and node 2 are in separate chassis of the FPGA application, a second, different protocol can be utilized. In yet another example, where node 1 and node 2 are within the same chassis of the FPGA application, a third, different protocol can be utilized. Moreover, a fourth protocol can be used for writing to memory within the FPGA application and a fifth protocol can be used for reading from memory within the FPGA application.

A secure stream programmable gate array capability can be provided in one embodiment, which allows for configuration steps to be quickly and easily carried out utilizing information contained within a message. For example, the configuration key information is extracted from the message, and appropriately utilized to select the applicable state to determine the applicable configuration information including encryption cyphers, process flow, and rules. The receiver makes use of precompiled control information, which is stored in memory directly accessible by the receiver to further accommodate this process. Extracted configuration key information can thus utilize a control stream or message header to appropriately coordinate with memory, and thus provide appropriate configuration for the receiver involved. Again, the same information stream is then processed through the receiver, to provide a desired output stream.

In operation, the receiver will apply rules to determine how to process the incoming data stream, and thus carry out the above-mentioned extraction of configuration information by providing this capability directly on hardware; the need for traditional general purpose processors is avoided. As a product of this, there is no operating system to operate the various nodes. Consequently, the reduced attack surface provides enhanced security and performance can be obtained.

One embodiment described herein is directed to a stream-triggered method for FPGAs. Alternatively, this is referred to as a stream programmable gate array (SPGA). The method utilized includes receiving an input stream directly from a network, triggering configuration of an FPGA processor based on the receiving of the input stream, and deterministically processing the received input stream through programmed hardware gates within the FPGA processor. Using this approach, all components are thus stream-triggered, and operate exclusively based upon information contained in the input stream. In alternative embodiments, additional possibilities exist where data in the input stream is combined with contextual information (e.g., stored locally in memory) to determine stream routing.

In one example, component 1 and component 2 each comprise an FPGA and logic to control the FPGA. In one embodiment, a node-to-node communication protocol is implemented on an I/O node, a PCI Express card, IoT embeddable module, or other device that employs a hardware unit that includes an FPGA. For example, the device could be a mobile device, tablet, phone, computer, server, and mainframe. In another embodiment, the nodes can be communicatively connected together in a common chassis, rack, or alternative container of hardware units. In some embodiments, components could be comprised of a device that could be worn, carried, used in groups, stand alone, or belong to a loosely coupled network.

In one embodiment, a message is received by a receiver, the message is not stored in any memory directly connected with the receiver, but rather is streamed through the receiver. The receiver performs stream processing, which is different than request and response processing. With stream processing, the receiver constantly inspects the contents of input messages for certain trigger information, and react accordingly when this information is discovered.

Depending on the content of a given message, a receiver may or may not process that input message, and may or may not generate an output message corresponding to that input message. As one example, the receiver does not process the input message when received but still propagates the input stream forward to another node. As another example, the receiver processes the input message upon receipt and generates a corresponding output message. As a further example, the receiver does not process the input message when received or only a portion thereof, and does not generate an output message corresponding to the input message (e.g., due to a fraudulent message). Moreover, the receiver can take various actions such as dropping communication, cancelling network bandwidth and other actions if it is determined a fraudulent message is received.

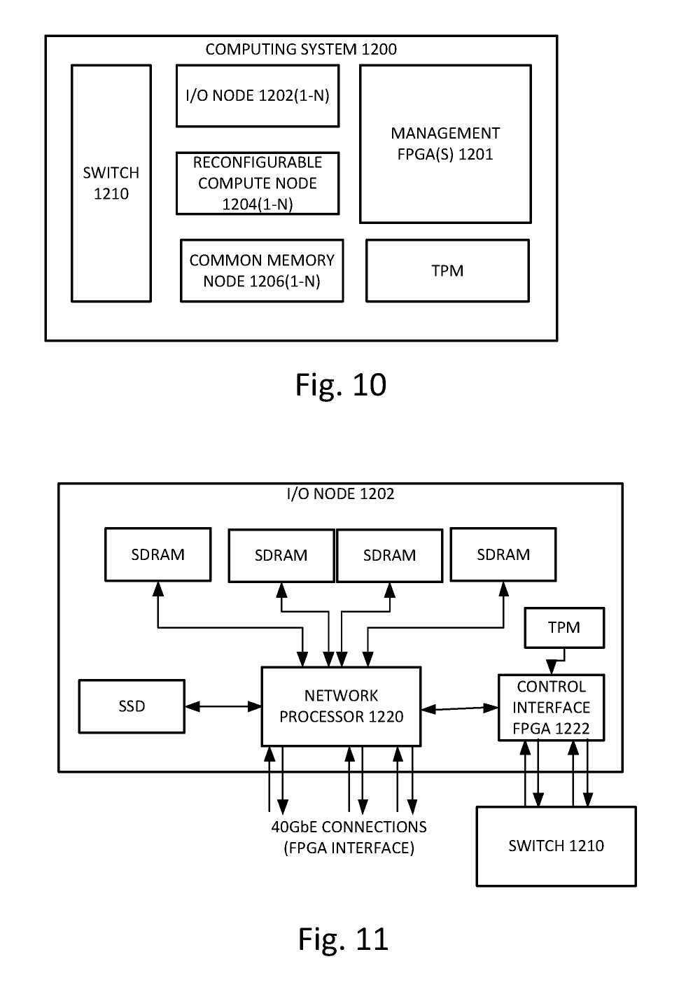

FIG. 10 illustrates a suitable computer system 1200 for implementing the concepts presented herein. In one example, a chassis for the system 1200 can be in 4 node, 32 node, fully enclosed electromagnetic pulse (EMP) protected cabinet with hundreds of nodes and rugged Signal Data Processor (SDP) form factors, utilizing various modules discussed below. The chassis can include a mix of input/output (I/O) nodes, reconfigurable compute nodes, each having one or more FPGA processors and an optional microprocessor, and common memory nodes. As illustrated in FIG. 10, the system 1200 includes one or more management FPGA processor(s) 1201, an I/O node 1202, a reconfigurable compute node 1204 and a common memory node 1206. For a 32 node chassis, multiple I/O nodes can be utilized as desired.

Unit to Unit interconnect within the chassis is established via a switch 1210. The switch can be embodied as component having the trademark HI-BAR®. Each of the selected modules can have HI-BAR® switch connections to effectuate node to node communication, for example as discussed above. In a further embodiment, switch 1210 can include an FPGA or direct execution logic to perform load balancing operations within a chassis or across a multi-chassis application. The switch 1210 can further include logic to implement secure protocols for node to node and chassis to chassis communication as particularly discussed with respect to FIG. 9.

The one or more management FPGA processors 1201 can be positioned on a motherboard for the system 1200, serving to connect with other portions of the system 1200 to control deployment of one or more FPGA application 102. In addition, the management FPGA processors 1201 can perform other control tasks as desired.

I/O node 1202, reconfigurable compute nodes 1204 and common memory nodes 1206 can be embodied on separate nodes affixed within a slot in a common chassis. In one embodiment, a 4 node chassis can include slots to accommodate four nodes. Depending upon requirements for development of a particular application, a selected configuration can include 1 I/O node 1202, 2 reconfigurable compute nodes 1204 and 1 common memory node 1206. For an FPGA application that utilizes more memory, a selected configuration can include 1 I/O node 1202, 1 reconfigurable compute nodes 1204 and 2 common memory nodes 1206. For FPGA applications with multiple 4 node chassis, various configurations are available, wherein FPGA compilation module 108 will generate communication protocols for chassis to chassis communication, as well as node to node communication.

In one embodiment, the use of the FPGA system 1200 is deployed as secured appliances. In an alternate embodiment, the FPGA system 1200 is used in conjunction with one or more Trusted Platform Modules (TPM) to provide attestation of the reconfigurable system. In yet another embodiment, the FPGA system 1200 is programmed using a bytecode which has been cryptographically signed by a second trusted system and verified to be valid by a key sealed inside the TPM. In a further embodiment, the key used to verify the bytecode's cryptographic signature is provided by a second external trusted system, which may or may not be a hardware security module (HSM) appliance. In a further embodiment, a TPM is used for multiple (or each) hardware component in the FPGA application. Additionally, a staged unlocking of an FPGA application 102 can be performed using the one or more TPMs. In one embodiment, more than one TPM can be used on more than one node to perform a staged unlocking of an FPGA application 102.

In one embodiment, the chassis and/or FPGA system 1200 will use secure cryptography processing and key management that meets financial industry and health industry standards, such as PCI-DSS, HIPAA and NIST standards for security and compliance as required for financial transaction processing, payment authorization, data protection, tokenization, and others. In one particular exemplary embodiment, the common chassis can also have a tamper-resistant HSM embedded in the chassis or implemented on a single card or cartridge contained within the chassis. In another embodiment, the chassis itself can be implemented as secure and tamper-resistant such that operations can halt for the entire chassis and/or HSM if the chassis detects that it has been compromised. In a further embodiment, the HSM is implemented using FPGA system 1200. In yet another embodiment, a TPM can be used in conjunction with the HSM or in concert with the HSM on the chassis or independently on the FPGA system 1200.

The switch 1210 is a scalable, high-bandwidth, low-latency switch. Each switch 1210 can support 64-bit addressing and input and of output ports to connect to a number of nodes. Switch 1210 can further be extended to address multiple chassis, such that addressing a particular location in memory is a message addressed with the form [chassis]-[node]-[memory location]. I/O nodes 1202, reconfigurable compute nodes 1204 and common memory nodes 1206 can all be connected to the switch 1210 in any configuration. In one embodiment, each input or output port sustains a yielded data payload of 3.6 GBs/sec. for an aggregate yielded bisection data bandwidth of 57.6 GB/sec per 16 ports. In another embodiment, port-to-port latency is 180 ns with Single Error Correction and Double Error Detection (SECDED) implemented on each port. In another embodiment, switches 1210 can also be interconnected in multi-tier configurations, allowing two tiers to support 256 nodes.

As illustrated in FIG. 11, the I/O node 1202 provides external connectivity to the system 1200, through a networked connection using Ethernet, Infiniband or another switch 1210 connected thereto. The I/O node 1202 can include a network processor 1220 (e.g., a Cavium® Octeon® III C78XX processor from Cavium, Inc. of San Jose, Calif.) that handles thousands of socket connections. I/O node 1202 can provide, for example, two 40 GbE connections from an external network to system 1200 for Ethernet. The network processor 1220 can convert incoming network traffic from Ethernet into traffic to the control FPGA interface 1222. The control FPGA interface 1222 provides the secure edge of the FPGA application 102. The control FPGA interface 1222 manages the communication with the switch 1210 for all inbound and outbound traffic for I/O node 1202. The network processor 1220 also has access to memory units, shown as an SSD device 1224 and separate SDRAM devices 1226. In another embodiment, the I/O node 1202 can include an FPGA or an FPGA can replace the network processor 1220 and programmed as discussed herein. In another embodiment, the I/O node 1202 can combine the network processor 1220 and the control FPGA interface 1222 as a single FPGA and be programmed as discussed herein.

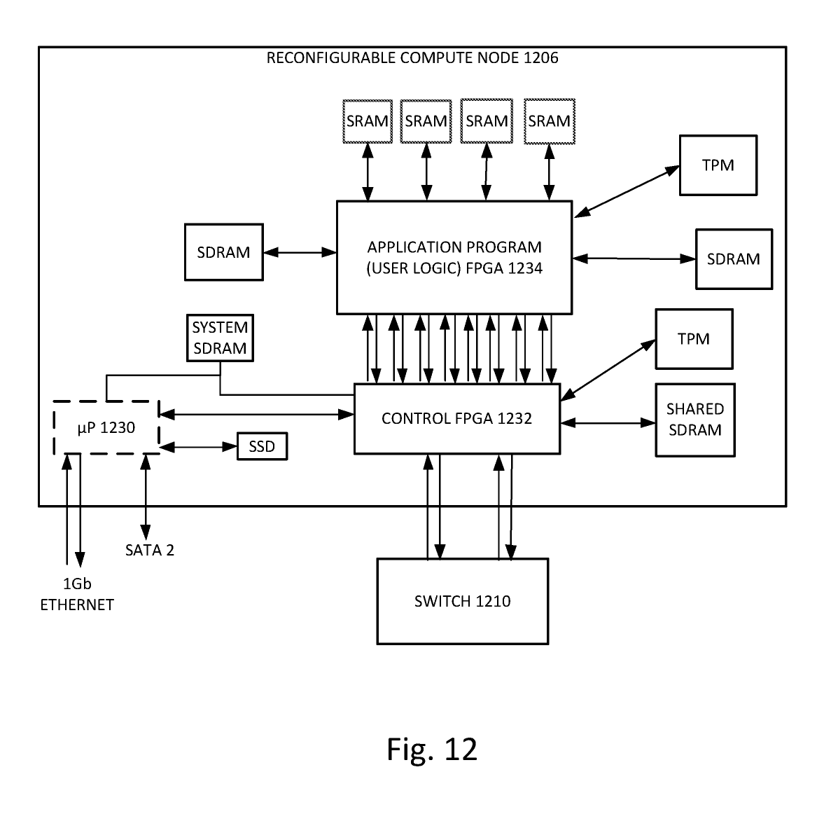

As shown in FIG. 12, the reconfigurable compute node 1206 includes an optional central processing unit (CPU) 1230, a control FPGA 1232, a user logic FPGA 1234 and a collection of memory devices, including SDRAM, SRAM and non-volatile memory. In one embodiment, the application FPGA is an Altera® Arria® 10 10AX115 FPGA. The control chip FPGA 1232 has an attached shared memory unit that is also accessible from the CPU 1230 and the user logic FPGA 1234. The control chip FPGA 1232 further has two switch ports for inter-module communication with the switch 1210.

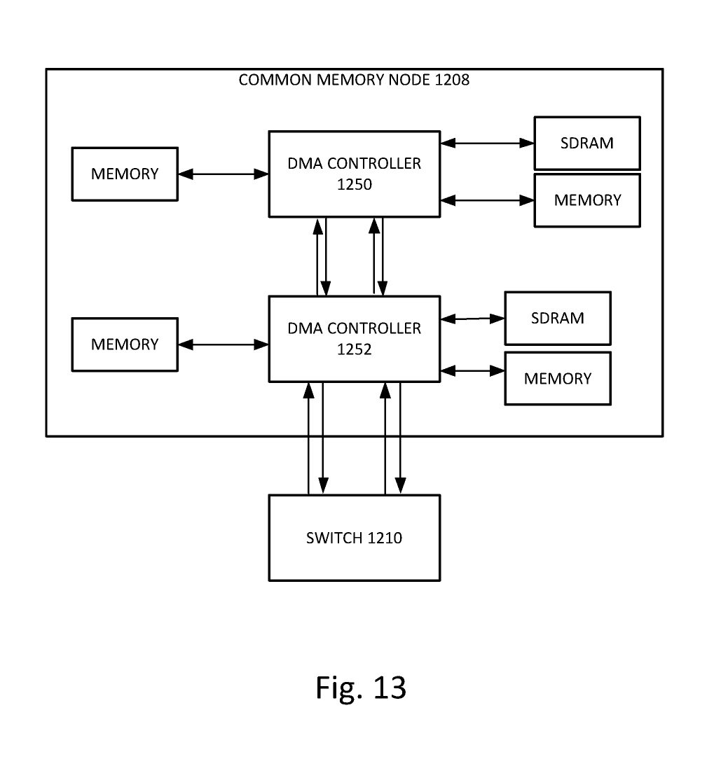

As illustrated in FIG. 13, common memory node 1206 provides large memory capability for system 1200. The common memory node 1206 as illustrated includes two DMA controllers 1250 and 1252 that can be using a block-addressing scheme. Access to the common memory node 1206 within system 1200 is shared between units in the chassis and can further be configured across different chassis. In one example, the common memory node 1206 includes 12 Solid State Drive (SSD) devices, connected through a six port PCIe switch, providing up to 48 Terabytes (TB) of non-volatile storage acting as common memory. Each DMA controller 1250 and 1252 is capable of performing complex DMA pre-fetch and data access functions such as data packing, striped access and scatter/gather, to maximize efficient use of system 1200.

Interconnect efficiencies more than 10 times greater than a cache-based microprocessor using the same interconnect are common for these operations. Each input or output port sustains a yielded data payload of at least 3.6 GB/sec. with Single Error Correction and Double Error Detection (SECDED) implemented on each port. The FPGA controllers 1250 and 1252 are for controlling memory operations, including supporting complex direct memory access (complex DMA). In one embodiment, the controllers are programmed to use complex direct memory access (complex DMA) to access memory. Using complex DMA, logic can be applied to data to be written to memory at the time it is written by including logic in the memory access command. The switch 1210 allows components on one node to directly access memory in another node using complex DMA.

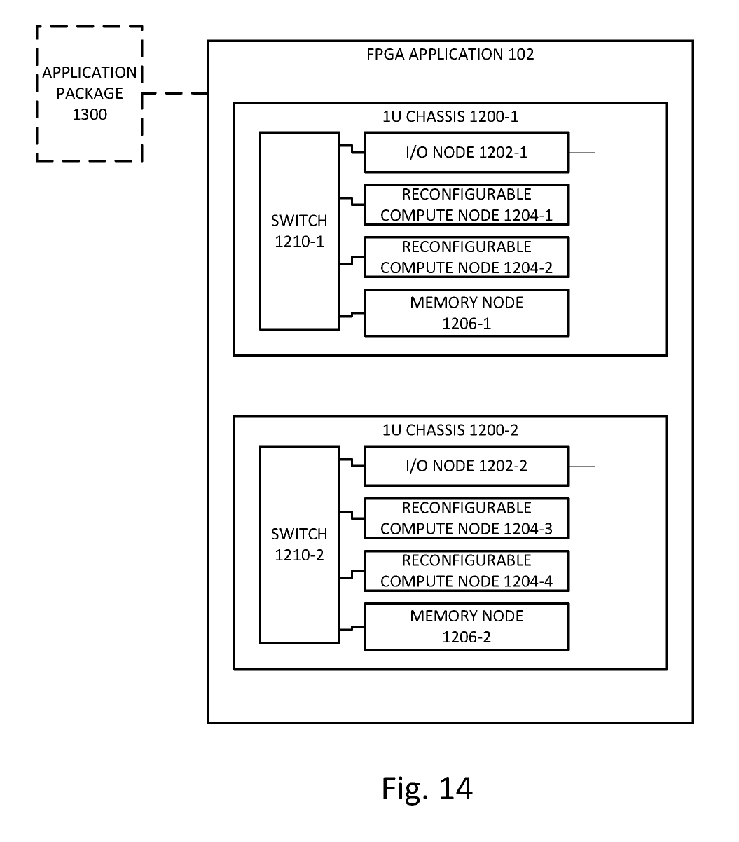

FIG. 14 schematically illustrates an example FPGA application 102 deployed onto a plurality of chassis, denoted as 4 node chassis 1200-1 and 4 node chassis 1200-2 from an application package 1300. Each chassis is equipped with an I/O node 1202-1 and 1202-2, respectively, for both communications received from and communications going out of the chassis 1200-1 and 1200-2. Each of the I/O nodes 1202-1 and 1202-2 include specified protocol execution logic for communication throughout the FPGA application 102. For example, the I/O nodes 1202-1 and 1202-2 can include specific protocol verification elements (or components) that process external messages (i.e., to ingress points of the FPGA application 102). Additionally, I/O node 1202-1 can include logic that is used for generating messages to be sent directly to compute nodes 1204-1 and 1204-2. As these messages are inter-chassis communications, the protocol used for this type of communication can be different than that used for receipt of external messages. Still further, I/O node 1202-1 can include a different protocol for communicating with memory node 1206-1. Application package 1300 can include direct execution logic that allows each node within the FPGA application 102 to include separate protocols where implemented to allow maximum flexibility and security preferences for communication both to FPGA application 102 and within FPGA application 102 in the manner detailed in FIG. 9.

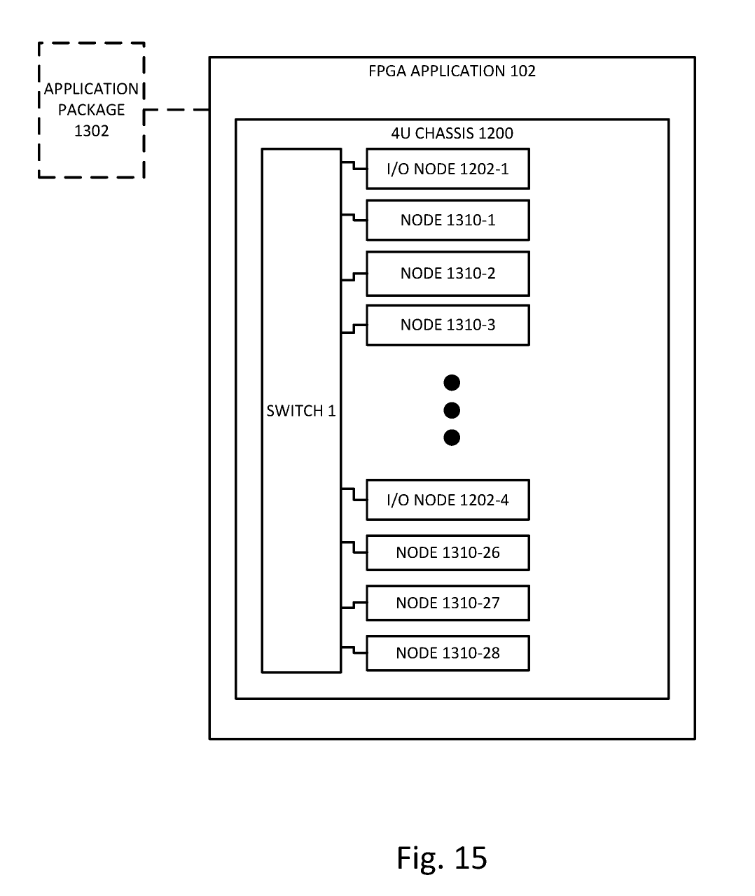

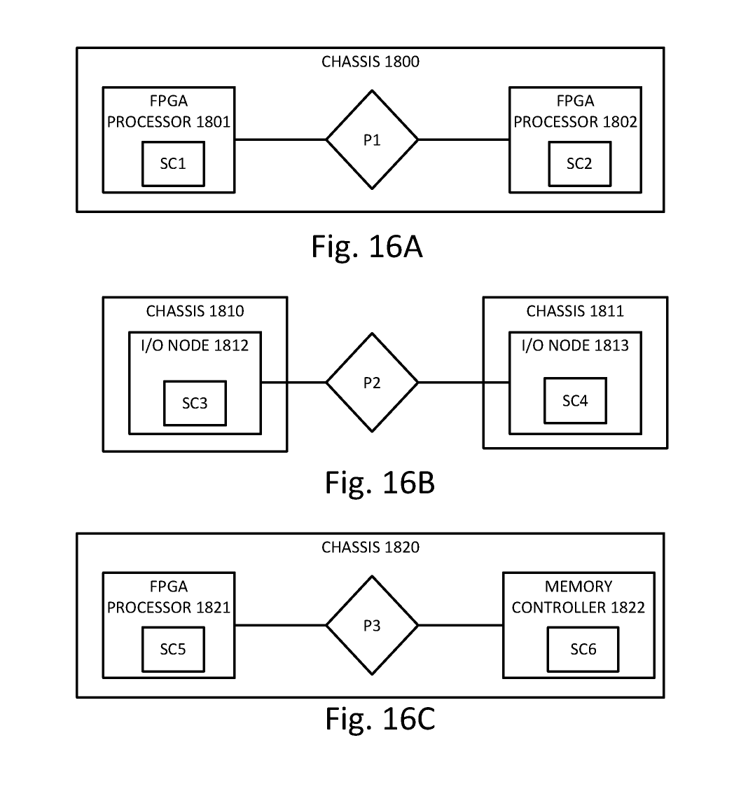

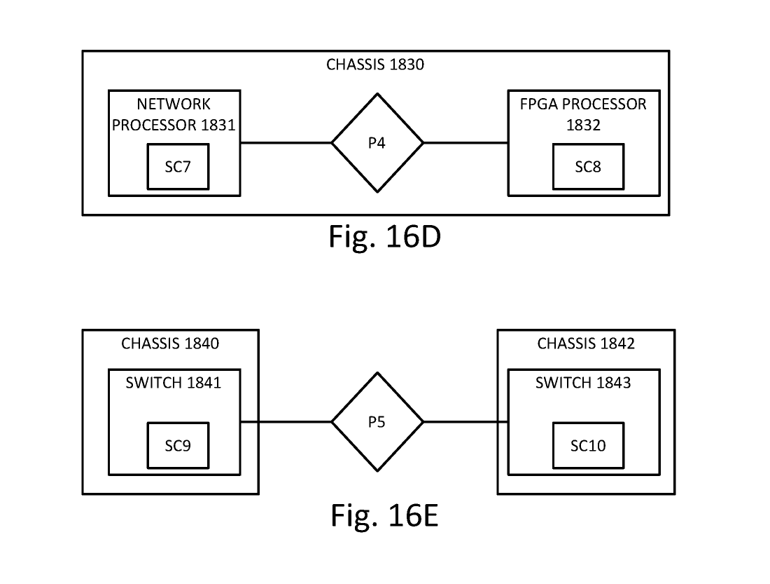

In a similar manner, FIG. 15 schematically shows an FPGA application 102 formed from an application package 1302 and deployed onto a single chassis with 32 nodes, denoted as nodes 1310-1 through 1310-32 of various configurations and I/O nodes 1202-1 to 1202-4. Application package 1302 includes direct execution logic to be deployed onto each of the nodes 1310 in the manner discussed above. Additionally, communication between the nodes can be implemented as discussed above with respect to FIG. 9.

Examples for various usage of protocols are schematically illustrated in FIGS. 18A-18E. The protocols can use any of the techniques described herein and in particular the structure and approach discussed above with respect to FIG. 9. In FIG. 18A, an intra-chassis protocol P1 is used within a chassis 1800 for communication between an FPGA compute node 1801 having stream connection code SC1 and an FPGA compute node 1802 having stream connection code S2. The FPGA compute nodes 1801 and 1802 are within the same chassis 1800 and a desired protocol P1 is used in communicating between the nodes and in particular stream connection code SC1 and stream connection code SC2. In some embodiments, a switch can be utilized to verify adherence to the protocol P1 and route to the correct destination. In further embodiments, more than one protocol can be used in intra-chassis communication.

FIG. 18B is a schematic illustration of using a protocols P2 for communication between a first chassis 1810 and a second chassis 1811. In particular, an I/O node 1812 having stream connection code SC3 in chassis 1810 communicates using protocol P2 to an I/O node 1813 having stream connection code SC4 in chassis 1811. In one embodiment, the two chassis 1810 and 1811 are connected via Ethernet or optical link and protocol P2 is selected to provide a desired security profile for communication between chassis 1810 and 1811. One or both of the I/O nodes 1812 and 1813 can be an FPGA processor as desired.

FIG. 18C is a schematic illustration of a chassis 1820 wherein a protocol P3 is utilized for an FPGA compute node 1821 using stream connection code SC5 to access memory through a memory controller node 1822 using stream connection code SC6. In one embodiment, the protocol P3 can ensure that the requesting FPGA compute node 1821 is authorized to access memory connected to the memory controller node 1822. The memory controller node 1822 can be embodied as an FPGA or other processor as desired. In a further embodiment, different protocols can be used for read and write operations.

FIG. 18D schematically illustrates a protocol P4 used within a chassis 1830. In this scenario, a network processor 1831 using stream connection code SC7 communicates using protocol P4 to an FPGA compute node 1832 using stream connection code SC8. The I/O node 1831 uses the protocol P4 to transmit operations to the FPGA compute node 1832 and stream connection code SC8.

FIG. 18E schematically illustrates a protocol P5 used for communication between a first chassis 1840 and a second chassis 1842. In particular, a HI-BAR® switch 1841 having stream connection code SC9 in chassis 1840 communicates using protocol P5 to a HI-BAR® switch 1843 having stream connection code SC10 in chassis 1842. In one embodiment, the two chassis 1840 and 1842 are connected via an optical link and protocol P5 is selected to provide a desired security and latency profile for communication between chassis 1840 and 1842. Both of the HI-BAR® switches are FPGA processor based.

The protocols P1-P5 can be used in several different ways and in several different instances as desired. Additionally, for an FPGA application, any different number of protocols can be used. These protocols can further be varied periodically as desired and used in various combinations. As such, security for a particular FPGA application can be enhanced.

Although the present invention has been described with reference to preferred embodiments, those skilled in the art will recognize that changes can be made in form and detail without departing from the spirit and scope of the present invention. The various embodiments of the invention have been described above for purposes of illustrating the details thereof and to enable one of ordinary skill in the art to make and use the invention. The details and features of the disclosed embodiment are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A computer implemented method, comprising:
receiving, by a processor, a first digital bit stream of data to a plurality of circuits, the plurality of circuits generated from a plurality of code blocks;
in parallel with processing the first digital bit stream of data through the plurality of circuits, generating a usage value indicative of execution of at least one of the plurality of circuits consuming the first digital bit stream;
transmitting, by the processor, a second digital bit stream indicative of the one or more usage values.

2. The computer implemented method of claim 1, wherein the processor is an FPGA.

3. The computer implemented method of claim 1, wherein processing the digital bit stream with the plurality of circuits and the generation of one or more usage values are conducted deterministically.

4. The computer implemented method of claim 1, further comprising aggregating a plurality of usage values.

5. The computer implemented method of claim 1, wherein generating a usage value is conducted by one or more metering circuits on the processor.

6. The computer implemented method of claim 1, wherein the usage value is indicative of a time interval.

7. The computer implemented method of claim 1, wherein the usage value is indicative of a number of times that one of the plurality of circuits was executed.

8. The computer implemented method of claim 1, wherein the usage value is indicative of an aggregation of execution of one or more of the plurality of circuits.
